(19) United States
(12) Patent Application Publication
(10) Pub. No.: US 2008/0252447 A1
(43) Pub. Date: Oct. 16, 2008

(54) COMBINATION SMOKE AND WATER DETECTOR

(76) Inventors: MIKE A ATHERTON, Mt. Holly, NC (US); Joe M. Farr, Lake Wylie, SC (US)

Correspondence Address: F. RHETT BROCKINGTON, 10613 KENNEL LANE, CHARLOTTE, NC, 28277, US

(21) Appl. No.: 11/870,553

(22) Filed: Oct. 11, 2007

Related U.S. Application Data
(60) Provisional application No. 60/853,142, filed on Oct. 20, 2006.

(51) Int. Cl. G08B 21/00

(52) U.S. Cl. 340/540

(57) ABSTRACT

The apparatus is a combination smoke and water detector. The smoke detector has an alarm and a test switch. The smoke detector is electrically connected to an open cell foam sensing pad through a pair of wire leads. The sensing pad is contained in a plastic housing having at least one water inlet hole. When the sensing pad is wetted with water, the pad becomes electrically conductive, by-passing the test switch and activating the alarm on the smoke detector. The apparatus is particularly suitable for detecting leaks.

### CROSS REFERENCE TO RELATED PATENT APPLICATIONS

The application claims the benefit of the priority filing date of the provisional application bearing Ser. No. 60/853,142, which was filed on Oct. 20, 2006.

### BACKGROUND OF THE INVENTION

1) Field of the Invention

The invention relates to an apparatus for detecting the presence of liquid water, and more particularly an apparatus that detects both smoke and water leaks, and upon detecting the presence of either, sounds an alarm.

2) Prior Art

Gustave A. Reis, in U.S. Pat. No. 4,841,282, discloses a liquid level detector, which utilizes a conventional smoke detector/alarm. The electrical circuitry is operatively associated with the ionization chamber and causes sounding of an alarm signal when the circuit detects that there is a lowered impedance. The liquid level detector comprises a sensor head having two spaced-apart electrodes, each in electrical communication with an electrically conductive lead. The leads are connected to the circuitry on either side of the ionization chamber so that the electrodes are in parallel. Liquid in contact with the electrode establishes a conductive path there between to complete the alarm circuit and cause the sounding of the alarm signal. The liquid level detector further comprises a non-conductive covering comprised of a flexible, waterproof material, such as a plastic. The covering encloses at least a portion of each electrode such that undesirable shorting or arcing there between is prevented. A small portion of each electrode remains uncovered by the insulating material to serve as the conductive path. Reis contemplates that one lead of the liquid level detector is in electrical contact with the housing of the ionization chamber, and the other lead is put in electrical contact with the test button. It is to be noted that since the liquid level detector is connected in parallel with both the ionization chamber and with the test button, operation of both of these features of a conventional smoke alarm are still operative. Hence, the functioning of the smoke alarm to detect the presence of smoke and gas remains unimpaired, as does the battery test function.

Stark et al., in U.S. Pat. No. 5,625,345, discloses a fire safety apparatus particularly useful in association with Christmas trees comprising: a smoke detector, circuitry for processing a signal generated by the smoke detector, an audible alarm, a moisture level sensor, and circuitry for interruption of the flow of electricity to a receptacle. Moisture sensing probes are provided which activate circuitry, which cause the alarm to be sounded when the moisture level contained in a Christmas tree base falls below a certain level. The circuitry activates one or more switches, thereby precluding the flow of electricity to the appliances plugged into the receptacle.

### SUMMARY OF THE INVENTION

The invention is an apparatus that is a combination smoke and water detector. The apparatus comprises a smoke detector having an electrical interface to at least one dielectric, water absorbing sensing pad. The smoke detector is comprised of a smoke sensor, a voltage comparator, an alarm, a smoke detector test load with a test switch that is normally open having a first electrical connection and a second electrical connection, and a source of electrical power. In operation, the smoke sensor has a change in impedance in the presence of smoke. The change in impedance results in a change in voltage which is sensed by the voltage comparator. The change in voltage causes the alarm to be actuated. The electrical interface with the smoke detector comprises a first electrical wire lead having a first end in electrical connection with the first electrical connection and a second end in electrical connection with a first terminal; a second electrical wire lead having one end in electrical connection with the second electrical connection and the other end in electrical connection with a second terminal. There is at least one dielectric water absorbent sensing pad that is in electrical communication with the first and second terminals. The sensing pad material and construction is selected to have high impedance when dry, thereby maintaining a substantially open circuit across the first and second terminals, and a lowered impedance when wetted with water, thereby providing a closed circuit across the first and second terminals. A closed circuit by-passes the test switch, and triggers the alarm to be actuated.

The alarm is an audible alarm and/or a combination of auxiliary devices such as a flashing light, or a signal to a network, an automatic telephone call, or a valve actuator (for instance on a water line). Some alarm systems are configured to be sympathetic, such that if one smoke alarm is actuated, all alarms are activated. Similarly, the invented apparatus can be configured as a sympathetic system for water and smoke, or water alone.

The apparatus can include multiple sensing pads, wherein one smoke detector monitors multiple sensing pads; wired either in parallel, series or a combination thereof. The sensing pad is selected to have high impedance when dry, lowered impedance when wet, to fit any space constraints, and to be absorbent. For instance, sensing pads that are positioned under a refrigerator are relatively flat because of the limited height. The sensing pad can be used with a catch pan for collecting water. Sensing pads that are positioned under the floor in the crawl space or basement may preferably be wired such that the alarm is on the topside of the floor, and only the electrical connection wires actually penetrate the floor. The sensing pad can be adhered, mechanically fastened, or resting on a supporting surface. Typically, thinner sensing pads are very sensitive to even small amounts of water, while thicker pads require more water to activate the smoke alarm. The sensing pad can be contained within a housing that is easily fastened to a surface. The housing can have walls that prevent water from reaching the sensing pad, therein establishing a threshold level of water before the alarm is actuated. The wire leads can further comprise a jumper switch for testing the circuitry of the water detector, the power supply, and the smoke detector's alarm.

### BRIEF DESCRIPTION OF THE DRAWINGS

The foregoing and other objects will become readily apparent by referring to the following detailed description and the appended drawings in which;

FIG. 1 is a schematic illustrating the invented combination smoke detector and leak detector, as well as various complementary components;

FIG. 2 illustrates various embodiments of a sensing pad;

FIG. 3 is a circuit diagram of the combination smoke detector and leak detector having a jumper switch;

FIG. 4a is a circuit diagram of three sensing pads wired in series; and

FIG. 4b is a circuit diagram of three sensing pads wired in parallel.

### DETAILED DESCRIPTION

The invention is an apparatus that is a combination smoke detector and water detector, wherein a conventional smoke detector is modified to also be a water detector particularly suited for detecting leaks. There are basically two versions of three different types of commercially available smoke detectors categorized according to their electrical power supply. The types are those which are solely battery powered; those which are solely powered by conventional A.C. power; and those which are A.C. powered and have a back-up battery. The third type of detector is intended to be primarily powered by A.C. with the back-up battery only providing power necessary to operate the detection and alarm circuitry in the event of loss of A.C. power. The two versions vary in whether they are configured to operate autonomously or configured to operate with other smoke detectors—forming a sympathetic system. The illustrated embodiment is battery powered; however, any of the three types or versions are suitable.

The invented combination smoke and water leak detector apparatus comprises a smoke detector alarm, and a water detector that utilizes the electronics if the smoke detector to analyze the electrical status of the water detection circuit 10.

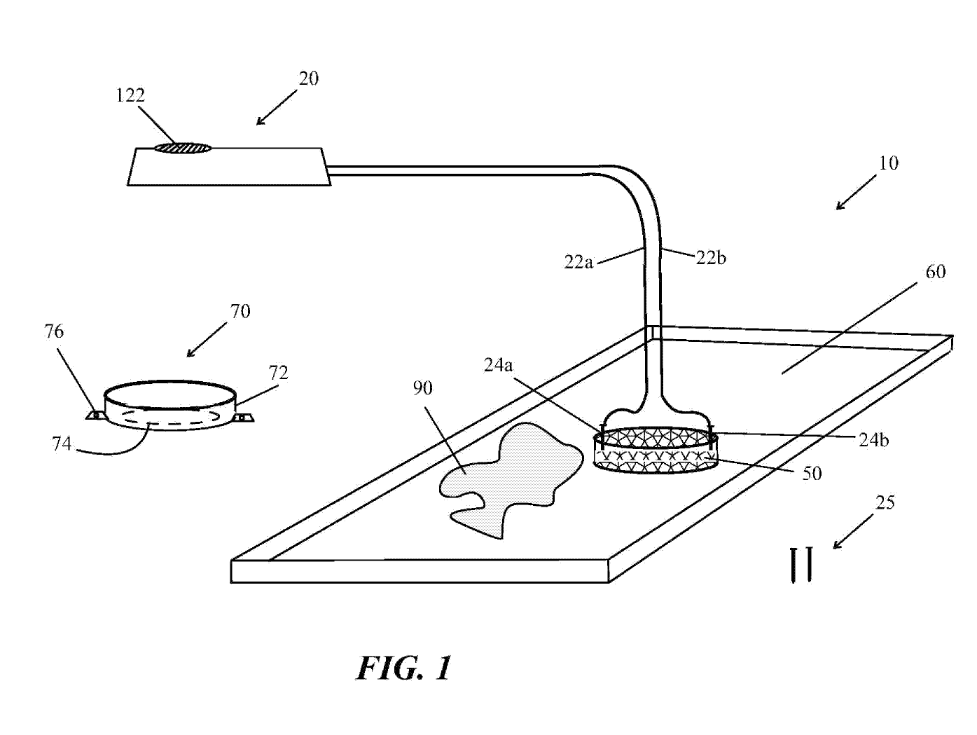

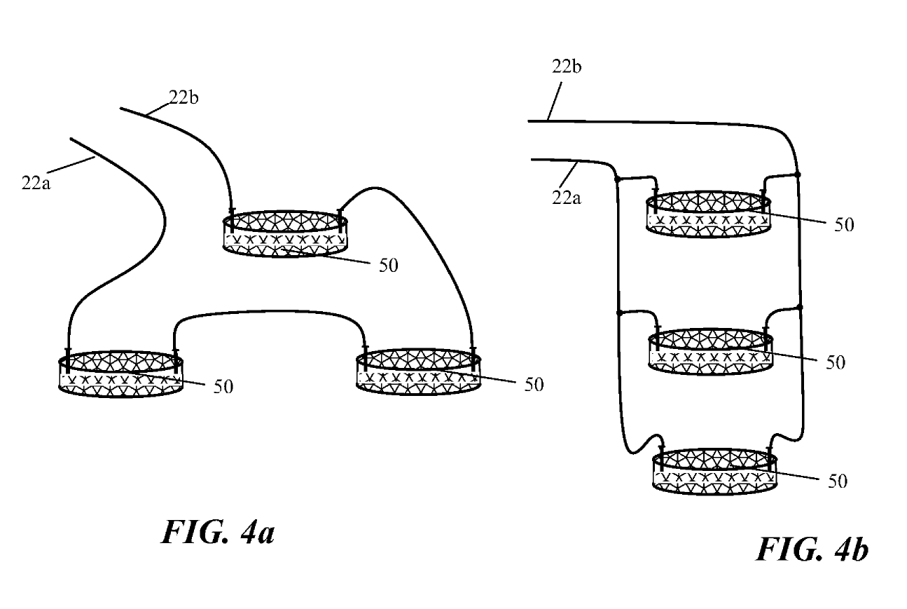

Referring to FIG. 1, there are pair of insulated wire leads 22a, 22b connecting the smoke detector 20 with alarm 122 to terminals embedded in the sensing pad 50. The sensing pad is comprised of a dielectric material that is water absorbent. The sensing pad, wire leads, and terminals substantially form the operational components of the water detection circuit 10. The terminals 24a, 24b are spaced apart, such that substantially most of the pad between the terminals must become wetted before the electrical resistance of the sensing pad 50 is sufficiently low to cause the alarm to sound. To facilitate the collection of water 2, the sensing pad 50 can be positioned in a catch pan 60, where the catch pan collects the surrounding water. The absorbent sensing pad 50 tends to soak up any water that collects in the pan 60 or drips/leaks onto the absorbent sensing pad 50. The terminals can be fabricated from very inexpensive materiel. A pair of nails 25 functions very effectively for the terminals. Being sharp on one end nails can be pushed into the pads, and they are small and can easily be attached to the wire leads with solder. Potentially, the nails can also be used to position the sensing pad. The sensing pad can also be fabricated from inexpensive materiel. Commercially available sponge material is suitable for the sensing pad. Commercial sponge material is typically an open cell foam, such as a polyurethane foam. The open cells provide a high impedance when dry, but when the cells are filled with water the resistance falls precipitously. Substantially no current flows through the water detection circuit 10 so long as the sensing pad remains dry. If water 90 contacts the sensing pad 50, then the pad absorbs the water, distributing it throughout the pad, and there is a drop in the pad's electrical resistance. Consequently, the voltage between the terminals 24a, 24b falls, and this is sensed by the smoke detector's voltage comparator 150 (see FIG. 4), which actuates the alarm 122, either directly or through some attendant smoke detector circuitry.

In FIG. 1 there is also illustrated a housing 70 for a sensing pad. The housing 70 has a wall 72, and a water inlet 74 shown in ghost as a dashed line. The housing 70 can have a fastening means for attaching the housing to a surface. In the illustrated embodiment the fastening means is a set of perforated tabs 76 that can receive screws or nails. Attachment can assume any orientation. For instance the sensing pad could be mounted upside down using the fastening means 76. For example, the sensing pad can be mounted under a floor or a roof. If the roof leaks or the floor has water dripping through a seam, then the apparatus will detect the water as it seeps through.

In the illustrated embodiment the top is open, such that water can enter the housing from the top or through the water inlet 74 on the bottom. The position of the water inlet can be selected to restrain water from reaching the sensing pad until a threshold level of water is obtained by selecting the position of the water inlet 74. For instance, if the water inlet 74 is on the wall 72, then water will not enter the housing until it reaches a level equivalent to the position on the wall.

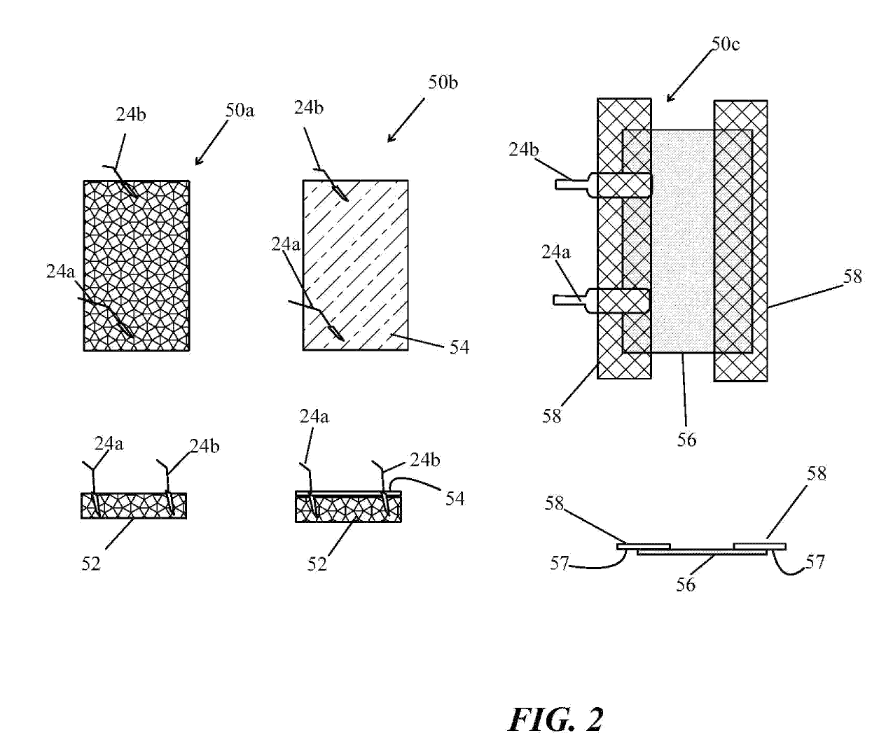

FIG. 2 illustrates three variations of the sensing pad 50a, 50b, and 50c, shown end-on and overhead. Sensing pad 50a is a relatively thick pad, comprised of an open cell absorbent material 52, such as a sponge, in which are embedded terminals 24a and 24b. Sensing pad 50a is substantially uniform throughout. Sensing pad 50b is a laminate comprised of an open cell material 52 and a filmic layer 54, which repels water. Sensing pad 50b only senses water that enters from the bottom or sides. In another variation, the sides could also have a filmic coating so that only water from the bottom would be detected. It is anticipated that the sensing pad could be mounted with any orientation, so that for applications, for instance, where it is desired to detect water on the side-walls of an appliance (garbage disposal) or a pipe (i.e. a sink drain line) where early detection is important, the sensing pad would detect water even before the leak reaches a horizontal plane. The third sensing pad 50c is a very thin pad, comprised of a nonwoven material 56 (i.e., paper towel or similar cellulosic material) to which are adhered the terminals 24a and 24b with adhesive tape strips 58. The strips overhang the perimeter of the thin water absorbent material 56, so that the adhesive 57 adheres the sensing pad 50c to an underlying surface, or can be wrapped around so that it adheres to itself, for instance in applications on a pipe or a bar.

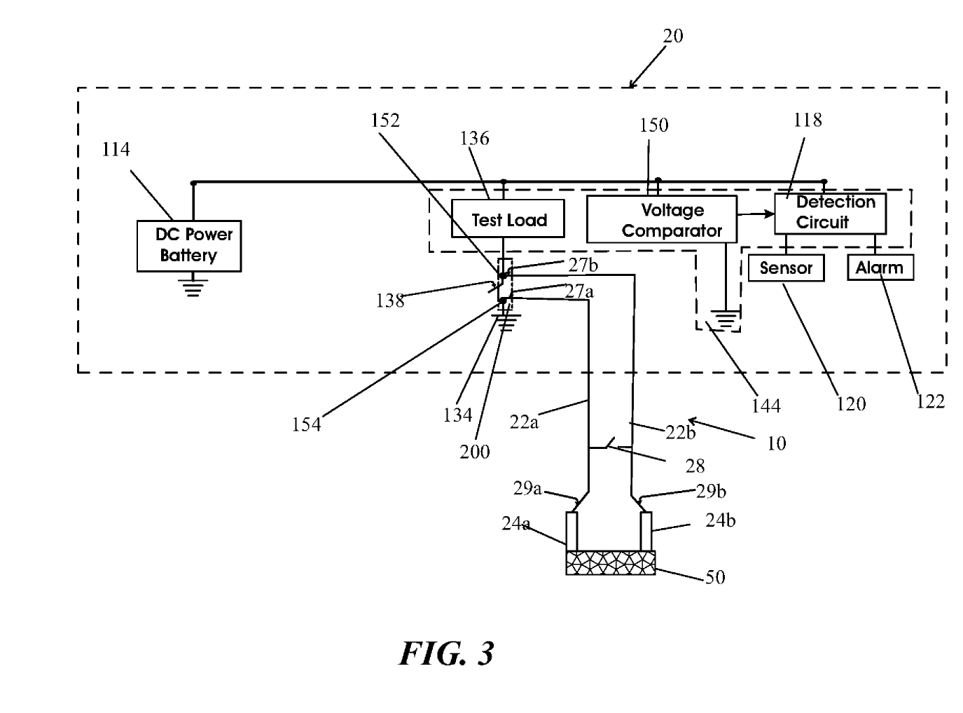

FIG. 3 is the circuit diagram for the apparatus. The long dashed light lines generally outline the circuit encompassing just the smoke detector 144, and short dashed lines delineate the components within the casing of the smoke detector 20. Short-long dashed light lines 200 generally outline the circuit (i.e. electrical interface) encompassing elements common to the smoke detector and the water detector. The water detector circuit is generally indicated by the arrow 10. When the voltage comparator 150 senses a drop in voltage, the alarm 122 is activated. There are several scenarios that operationally can cause the voltage comparator 150 to see a change in the voltage. In the case of the smoke detector, when the smoke detector sensor 120, which is controlled by the detection circuit 118, senses smoke, there is a change in the impedance over the smoke sensor 120. Consequently, the voltage comparator sees a change in voltage, and the detection circuit 118 actuates the alarm. The smoke detector has a test mode for operationally determining that the alarm works, and that the power source 114 is functioning properly. The power source 114 is a DC source such as a battery or a DC power supply connected to AC current. To use the test mode, the smoke detector has a test load 136 that is an electrical resistor, and a test switch 138, which is normally open. The test switch 138 has a first electrical connection 152 and a second electrical connection 154 that are nodes for the test switch 138 and a common ground 134, that is negative. When the test switch is pressed (e.g. closed), current flows through the test load, there is a drop in voltage and this causes the smoke alarm 122 to be activated, thus assuring that the test was positive. In the water detection mode, a first electrical wire lead 22b has a first end 27b in electrical connection with the first electrical connection 152 and a second end 29b in electrical connection with a first terminal 24b. A second electrical wire lead 22a has one end 27a in electrical connection with the second electrical connection 154 and the other end 29a in electrical connection with a second terminal 24a. The terminals 24a, 24b are embedded in a dielectric, water absorbing sensing pad 50. The sensing pad material is selected to have high impedance when dry, functioning operationally as an open switch. When wetted with water, the sensing pad absorbs water, and even if the water is very pure, there is enough drop in impedance that some current will flow (e.g. therein functioning operationally as a closed switch), and the voltage comparator 150 will see a drop in voltage. When there is a drop in voltage, the alarm 122 is actuated. Like the smoke detector, the water detector can also have a jumper switch 28, which operationally tests the water detector circuit 10, the alarm 122, and the functioning power source 114.

FIG. 4a and FIG. 4b illustrate that a plurality of sensing pads can be wired in series, parallel or a combination thereof to achieve different results. The physical position of the pad is influential on the results as water always seeks the lowest level. For example, a basement floor often slopes to a sump pump or drain. It is normal to periodically have some water, and still not have a flood condition. When the sensing pads are wired in series as shown in FIG. 4a, the alarm will not be actuated until all three of the sensing pads are wetted. Therefore, by placing the sensing pads at progressively higher elevations, the alarm will not sound until the water level is high enough to wet all three sensing pads 50. If the same three sensing pads were wired in parallel, then as soon as one sensing pad becomes wetted then the alarm is actuated. Parallel wiring would be applicable particularly in situations where a water leak could occur over a large surface, and it was desired to have early warning. Parallel wiring also provides redundancy, so that if one sensing pad fails, another parallel pad will back it up.

In another embodiment, each pad is wired to a dedicated smoke detector, and the individual smoke detectors interface a micro-processor, providing a single on/off bit. The micro-processor analyzes the state of each alarm as on or off. As previously stated, the alarm on the smoke detector need not be audible, but can be a light, a signal, and the like. The micro-processor follows the level and/or location of the water based on the signals received from a plurality of apparatus that detect both smoke and water leaks.

The descriptions above and the accompanying drawings should be interpreted in the illustrative and not the limited sense. While the invention has been disclosed in connection with the preferred embodiment or embodiments thereof, it should be understood that there may be other embodiments which fall within the scope of the invention as defined by the following claims. Where a claim is expressed as a means or step for performing a specified function, it is intended that such claim be construed to cover the corresponding structure, material, or acts described in the specification and equivalents thereof, including both structural equivalents and equivalent structures.

What is claimed is:

1. An apparatus that is a combination smoke and water detector, said apparatus comprises:
a smoke detector comprising a smoke detection electrical circuit with a smoke sensor, a voltage comparator, an alarm, a smoke detector test load with a test switch that is normally open having a first electrical connection and a second electrical connection, and a source of electrical power; where when the smoke sensor has a change in impedance in the presence of smoke, said change in impedance causes a voltage change which is measured by the voltage comparator, where upon the alarm is actuated;
an electrical interface with the smoke detector comprising a first electrical wire lead having a first end in electrical connection with the first electrical connection and a second end in electrical connection with a first terminal; a second electrical wire lead having one end in electrical connection with the second electrical connection and another end in electrical connection with a second terminal; and
at least one dielectric, water absorbing sensing pad in electrical communication with the first and second terminal, where said sensing pad has high impedance when dry, thereby maintaining a substantially open connection across the first and second electrical connection, and a lower impedance when wetted with water, thereby providing a closed connection across the first and second electrical connection resulting in a voltage change, said voltage change triggering the alarm to be actuated.

2. The apparatus according to claim 1, wherein said first and second terminals are embedded in the at least one sensing pad.

3. The apparatus according to claim 1, wherein said dielectric, water absorbing sensing pad is composed of an open cellular material.

4. The apparatus according to claim 3, wherein said sensing pad is a sponge material.

5. The apparatus according to claim 4, wherein said sponge material is open cell polyurethane foam.

6. The apparatus according to claim 1, wherein two or more dielectric, water absorbing sensing pads are connected in parallel to the first and second terminals, where if any of the sensing pads become wetted with water, the alarm is actuated.

7. The apparatus according to claim 1, wherein two or more dielectric, water absorbing sensing pads are connected in series to the first and second terminals, where only if all of the sensing pads become wetted with water, is the alarm actuated.

8. The apparatus according to claim 1 farther comprising a catch pan, wherein the at least one dielectric, water absorbing sensing pad is positioned within the catch pan.

9. The apparatus according to claim 1, wherein the at least one dielectric, water absorbing sensing pad is in a housing having at least one water inlet hole.

10. The apparatus according to claim 1, wherein the housing is selected to retain water from reaching the at least one sensing pad until a threshold level of water is obtained, or to facilitate the positioning of the at least one dielectric, water absorbing sensing pad.

11. The apparatus according to claim 1, wherein the at least one sensing pad is selected to have a desired sensitivity to water, where a thinner sensor pad is faster to respond to a slow water leak than a thicker sensor pad.

12. The apparatus according to claim 1, wherein the alarm is an audible alarm and/or a combination of auxiliary devices such as a flashing light, or a signal to a network, an automatic telephone call, or a valve actuator to shut off a water line.

13. An apparatus that is a combination smoke and water detector, said apparatus comprises:
a smoke detector with an alarm and a test switch;
an electrical interface across the test switch of the smoke detector comprising a first insulated electrical wire lead having a first end in electrical connection with the smoke detector and a second end in electrical connection with a first nail; a second insulated electrical wire lead having one end in electrical connection with the smoke detector and another end in electrical connection with a second nail; and
a dielectric spongy material sensing pad in electrical communication with the first and second nail, wherein the nails are embedded in the sensing pad; and wherein when water comes into contact with the sensing pad, the water is absorbed by the sensing pad; the water provides an electrical path through the dielectric spongy material sensing pad by-passing the test switch; and the alarm is activated.

14. The apparatus according to claim 13 wherein said sponge material is an open cell polyurethane foam.

15. The apparatus according to claim 13, where said sensing pad is contained in a plastic housing having at least one water inlet hole.

16. An apparatus that is a combination smoke and water detector, said apparatus comprises:
a smoke detector with an alarm and a test switch;
an electrical interface across the test switch of the smoke detector comprising a first insulated electrical wire lead having a first end in electrical connection with the smoke detector and a second end in electrical connection with a first terminal; a second insulated electrical wire lead having one end in electrical connection with the smoke detector and another end in electrical connection with a second terminal; and
a spongy material sensing pad in electrical communication with the first and second terminal, wherein the terminals are embedded in the sensing pad; and wherein when water comes into contact with the sensing pad, the water is absorbed by the sensing pad absorbs; the water provides an electrical path through the dielectric spongy material sensing pad by-passing the test switch; and the alarm is activated.

17. The apparatus according to claim 16 wherein said sponge material is an open cell polyurethane foam.

18. The apparatus according to claim 16, where said sensing pad is contained in a plastic housing having at least one water inlet hole.
